(19) United States
(12) Patent Application Publication
(10) Pub. No.: US 2015/0013635 A1
(43) Pub. Date: Jan. 15, 2015

(54) Engine Combustion System

(71) Applicant: Mark Brooks, Hillsboro, MO (US)

(72) Inventor: Mark Brooks, Hillsboro, MO (US)

(21) Appl. No.: 14/329,338

(22) Filed: Jul. 11, 2014

Related U.S. Application Data
(60) Provisional application No. 61/844,941, filed on Jul. 11, 2013.

(51) Int. Cl. F02B 75/32

(52) U.S. Cl. CPC F02B 75/32
USPC 123/197.3

(57) ABSTRACT

An engine combustion system includes a power cylinder and a gear assembly, the piston having respective intake and exhaust valves. The power cylinder includes a connecting rod pivotally attached to a bottom of the piston and extends vertically downwardly in vertical alignment with a gear assembly. A movable rack gear is coupled to the connecting rod and in communication with a rotatably mounted central gear. When an air/fuel mixture is ignited within the power cylinder fuel chamber, the connecting rod is urged downward causing linear movement of the rack gear in operative communication with the rotatably mounted central gear such that the power generated thereby is translated to a vehicle transmission or power train without angular inefficiency of a traditional crankshaft system.

### CROSS REFERENCE TO RELATED APPLICATION

This patent application claims the priority of U.S. Provisional Patent Application No. 61/844,941 filed on Jul. 11, 2013 titled “Engine Combustion System” which is incorporated by reference in its entirety herein.

### BACKGROUND OF THE INVENTION

This invention relates generally to combustion engines and, more particularly, to a piston, cylinder, and gear assembly that improves the efficiency and power stroke output of an engine.

A traditional internal combustion engine utilizes a crankshaft that operates one or more pistons and cylinders at first to compress an air/fuel mixture and then to ignite the compressed mixture to push the piston down and impart force to the crankshaft. A rod connects the crankshaft to the piston and it is the rod that causes the crankshaft to rotate upon combustion of the air/fuel mixture. The combustion that causes the crankshaft to rotate with increased velocity is called the “power stroke” and is what generates the engine's “horse power.” Therefore, it is important that the operation of the engine's combustion system generate a maximum amount of power with minimal inefficiency.

One reason for inefficiency in a traditional engine rod-crankshaft configuration is that the rod is pushed downward relative to the crankshaft at less than a 90 degree angle. In other words, maximum effort is achieved when the rod and crankshaft are at a true 90 degree geometry. Although existing systems are assumably effective for their intended purposes, they introduce inefficiencies that prevent maximum force from being harvested from each piston cycle.

Therefore, it would be desirable to have an engine combustion system in which the rod is always oriented at a 90 degree angle relative to the crankshaft at all times. Further, it would be desirable to have an engine combustion system that reduces or eliminates inefficiencies suffered by traditional engine combustion systems.

### SUMMARY OF THE INVENTION

A combustion system for use with a vehicle having a transmission according to the present invention includes a power cylinder having a continuous side wall defining an interior area and having an upper end and an opposed lower end, the power cylinder having an intake valve and an exhaust valve situated at the upper end. The power cylinder defines an air/fuel chamber adjacent the upper end. A piston is situated in the interior area and movable between the upper end and the lower end. A rod having a first end is pivotally connected to a bottom of the piston and extending downwardly therefrom to an opposed second end. A gear assembly is coupled to the second end of the rod, the gear assembly being selectively movable in the interior area according to movement of the piston and the rod.

The gear assembly includes a 360 degree rack gear member and a central gear situated in the interior area of the power cylinder and in operative communication with the rack gear member, the central gear being configured to rotate when the gear assembly is moved upwardly or downwardly in the interior area. A power shaft is fixedly coupled to the central gear and configured to rotate when the central gear is rotated, the power shaft being operatively coupled to the transmission of the vehicle.

When an air/fuel mixture is ignited within the power cylinder fuel chamber, the piston and connecting rod is urged downward causing linear movement of the rack gear in operative communication with the rotatably mounted central gear such that the power generated thereby is translated to a vehicle transmission or power train without angular inefficiency of a traditional crankshaft system.

Therefore, a general object of this invention is to provide a combustion system for an engine that improves the efficiency of an internal combustion engine.

Another object of this invention is to provide a combustion system, as aforesaid, that positions a piston rod in nearly perpendicular orientation relative to a power shaft at all times.

Still another object of this invention is to provide a combustion system, as aforesaid, that generates more power than a traditional engine.

A further object of this invention is to provide a combustion system, as aforesaid, that is cost effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIGS. 1a to 1d are schematic views of a traditional combustion system illustrating operation of a piston and crankshaft in various configurations of operation;

FIG. 2a is a schematic view of a power cylinder according to a preferred embodiment of the present invention showing the power cylinder at an intake configuration;

FIG. 2b is a schematic view of a power cylinder according to a preferred embodiment of the present invention showing the power cylinder at a compression configuration;

FIG. 2c is a schematic view as in FIG. 2a showing the power cylinder at combustion, i.e. at the “power stroke” configuration;

FIG. 2d is a schematic view as in FIG. 2 showing the power cylinder at an exhaust configuration just after combustion;

FIG. 3 is a perspective view of a single power cylinders operatively coupled to an overhead valve cam having a valve train and cam shaft in communication with respective power cylinders (not shown), respectively;

FIGS. 4a, 4b, 5a, and 5b are schematic views of the power cylinder illustrating operation of a piston, connecting rod, and gear assembly in various configurations of operation; and

FIG. 6 is a front view of the plurality of power cylinders exploded from the overhead valve cam;

FIG. 7 is a side view of the view of the plurality of power cylinders as in FIG. 6; and

FIG. 8 is a side view of a case surrounding the plurality of power cylinders as in FIG. 7.

### DESCRIPTION OF THE PREFERRED EMBODIMENT

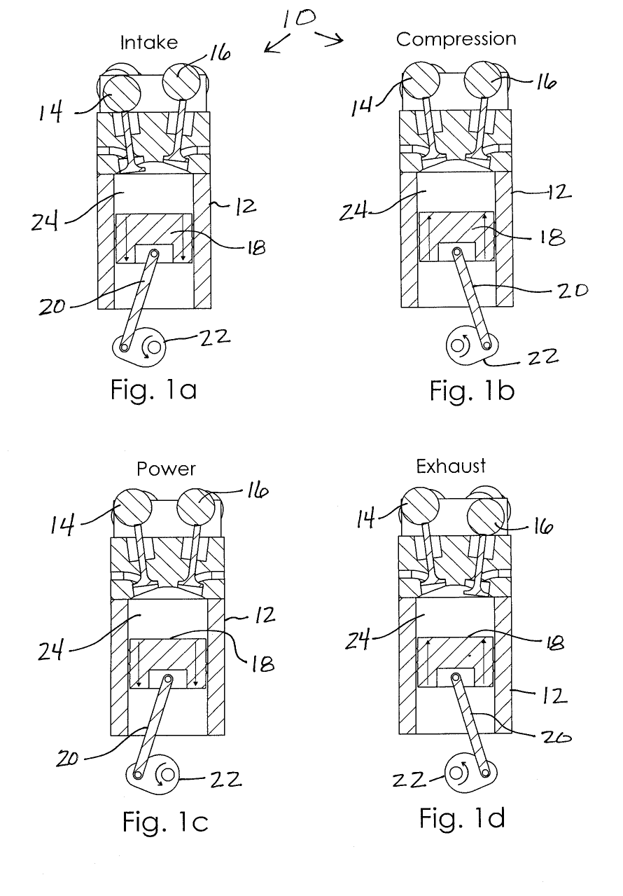

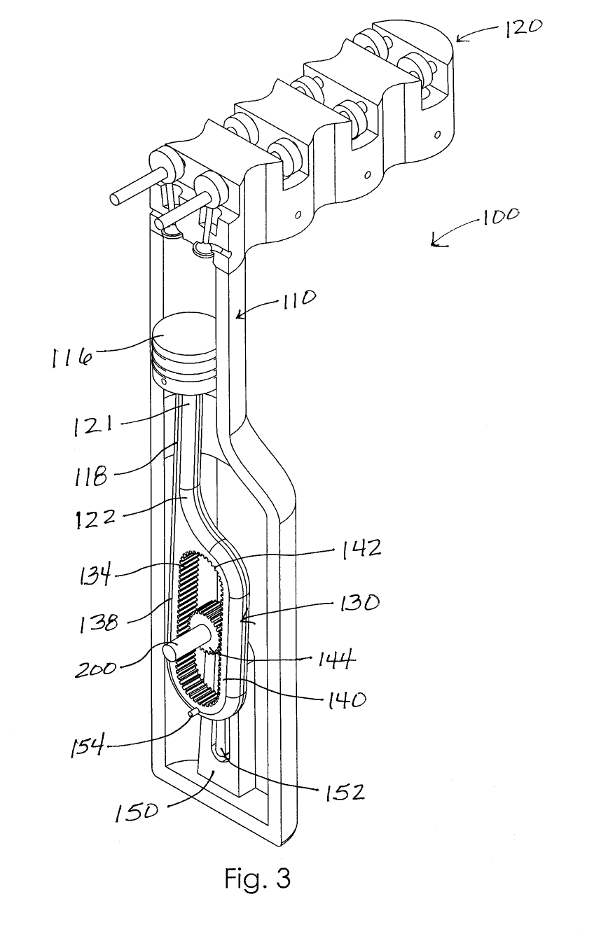

A combustion system according to a preferred embodiment of the present invention will now be described with reference to FIGS. 1 to 8 of the accompanying drawings. The preferred combustion system 100 generally includes a power cylinder 110 and a gear assembly 130.

FIG. 1 illustrates a traditional engine combustion system 10 having a cylinder 12, the cylinder 12 including an intake valve 14, an exhaust valve 16, and a piston 18 movably mounted within the cylinder 12. A rod 20 connects a lower end of the piston 18 to a crankshaft 22 that is configured to rotate axially. In the traditional combustion system as in FIG. 1, an air/fuel mixture is introduced into the cylinder 12 when the intake valve 14 is open and the piston 18 is moving downward within the cylinder 12. The air/fuel mixture is then compressed as the piston 18 moves upward, the piston 18 being urged upward by rotation of the crankshaft 22 and corresponding upward movement of the rod 20 extending therebetween as is well known in the art (FIG. 1b). When fully compressed, i.e. the piston 18 is at or near an uppermost configuration within the cylinder 12, a sparkplug (not shown) provides a spark so as to cause combustion of the compressed air/fuel mixture. This combustion causes a dramatic expansion of the volume of the fuel and the piston 18 is urged downward within the cylinder 12. This movement of the piston 18 exerts a downward movement of the rod 20 which causes the crankshaft 22 to rotate rapidly and generate power (FIG. 1c). The generation of power due to combustion of the air/fuel mixture is known as the “power stroke.” Rotation of the crankshaft 22 then urges the rod 20 and piston 18 upwards and the combusted fuel is exhausted through the exhaust valve 16 (FIG. 1d).

Unfortunately, the rod 20 is not in a completely vertical or 90 degree orientation relative to the crankshaft 22 at the point of combustion. Therefore, less than 100% of the force of combustion is transferred to the crankshaft. In other words, the power stroke is inefficient. Repeated cycles of the piston 18 magnify this inefficiency. The present invention eliminates this inefficiency by configuring the piston at ninety degrees relative to the crankshaft at the time of combustion as will be described in detail below. In other words, the power stroke will now harness 100% of the power generated through combustion and transfer it to the “crankshaft” although a traditional crankshaft is not used as will be described in more detail below.

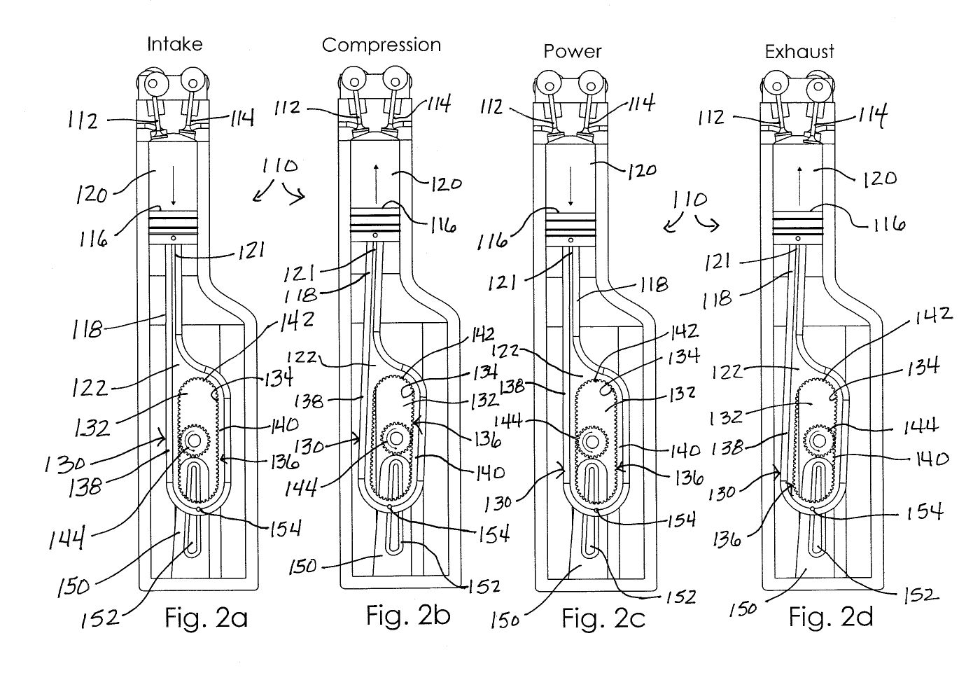

The present invention provides an improvement on the traditional system 10 described above. More particularly, FIGS. 2a to 2d show the improved combustion system 100 which includes a power cylinder 110 having a continuous side wall defining an interior area and including an upper end and an opposed lower end. The power cylinder 110 includes an intake valve 112 and an exhaust valve 114 situated at the upper end. The power cylinder 110 defines an air or fuel chamber 120 adjacent the upper end.

The power cylinder 110 includes an internal piston 116 that is movable between upper and lower ends of the power cylinder 110 and is fixedly connected to a connecting rod 118 (also referred to simply as the “rod”), the connecting rod 118 having a first end 121 being pivotally coupled to a bottom of the piston 116. The connecting rod 118 extends downwardly away from the piston 116. This pivotal connection enables the rod 118 to stay in generally vertical alignment with the gear assembly 130 at all times during operation of the power cylinder as described below.

The connecting rod 118 includes a second end 122 opposed to said first end 121. The second end 122 of the connecting rod 118 is connected to the gear assembly 130, the gear assembly 130 extending downwardly in the interior area of the power cylinder 110. The gear assembly 130 defines an interior “cutout” area having a generally oval configuration. An interior wall (also referred to as a peripheral surface) extends about the cutout 132 and includes a plurality of gear teeth 134 supported thereon or defined thereby. The plurality of teeth 134 form a 360 degree rack gear 136. More particularly, the rack gear 136 includes a first rack portion 138 opposite/facing a second rack portion 140, the ends of which are connected with end rack portions 142 which may otherwise be referred to as spur gears. Each portion includes a plurality of teeth.

The gear assembly 130 includes a central gear 144 rotatably mounted in the power cylinder 110 and is at all times positioned within the cutout area 132 of the gear assembly 130. The central gear 144 may be rotatably coupled to the continuous side wall of the power cylinder. While rotatable in a manner expected of a gear, it is understood that the central gear 144 is not movable between upper and lower ends in the manner of the piston 116, rod 118, and remainder of the gear assembly 130. Rather, the rack portions of the gear assembly 130 move around the central gear 144 in operation.

The central gear 144 is fixedly coupled to a power shaft 200 such that the power shaft 200 is axially rotated when the central gear 144 is rotated. It is understood that the power shaft 200 is operatively coupled to the transmission and axle of the automobile so as to transfer mechanical power thereto. The rod 118 defines an imaginary vertical axis that is aligned with the rack gear 130. By contrast, the central gear 144 and power shaft 200 define and share an imaginary horizontal axis, the axes being generally perpendicular to one another.

The gear assembly 130 may include a support member 150 defining a slot 152 that registers with a pin 154 (also referred to as a flange) in order to keep the gear assembly 130 more securely coupled together. In other words, the slot 152 is configured to receive the pin 154 so as to enhance the smoothness and stability of the up and down movement of the gear assembly 130 in operation.

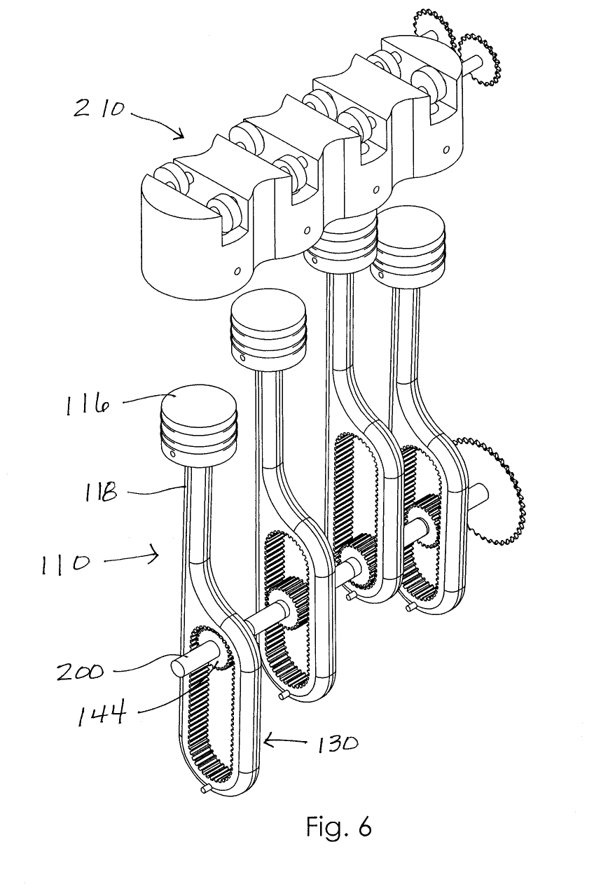

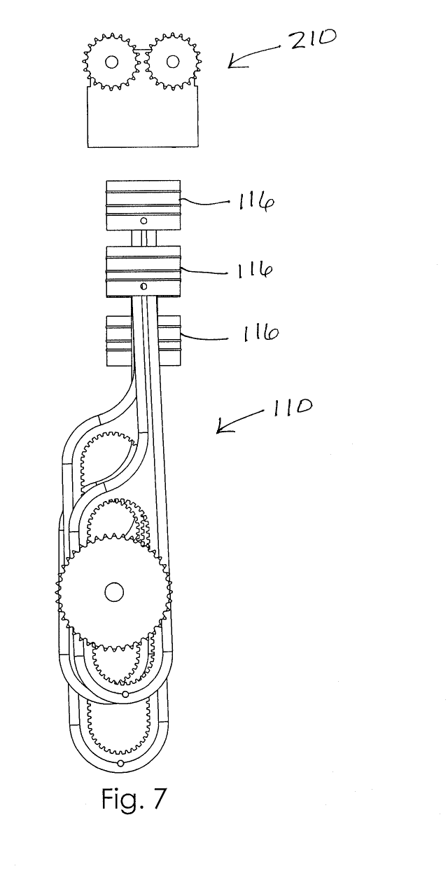

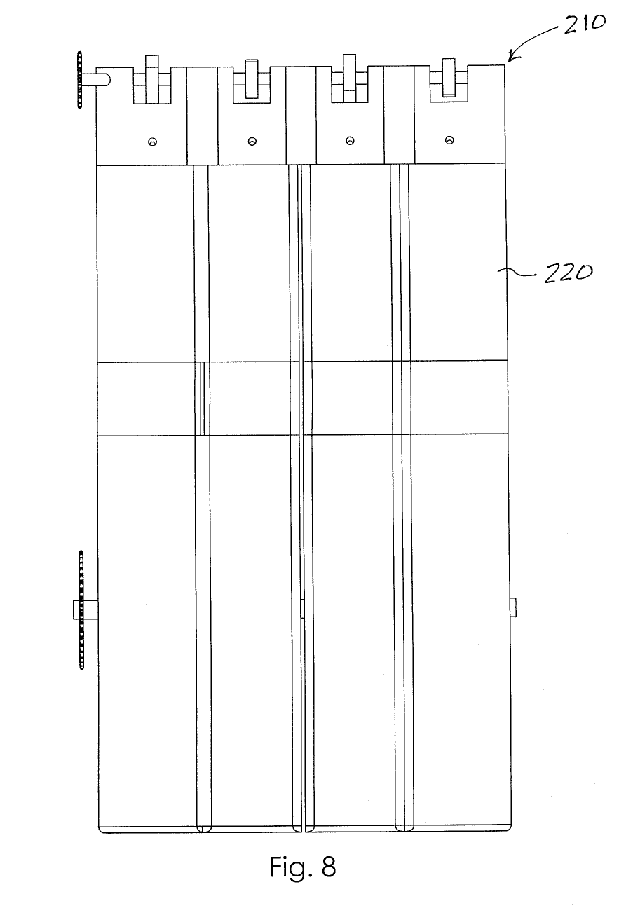

FIG. 6 illustrates four power cylinders 110 exploded from an overhead cam 210 having a 4-valve valve train as would be used in a 4-stroke engine using the present invention. As would be expected, FIG. 6 shows respective pistons firing at different times and being in different positions of a power stroke cycle. Importantly, however, the present design enables maximum power generation at all stages of the stroke—an advantage that is not provided by a conventional crankshaft system due to the inefficiencies discussed above. Specifically, the power shaft 200 is rotated both on the upstroke and the downstroke of the piston 116. Therefore, the present system is able to generate much more power using the same or less fuel. In addition, it is shown that each power cylinder 110 can be more narrow (smaller diameter) in that there does not need to be room for a rotating crankshaft. FIG. 7 illustrates a side view of the plurality of power cylinders and FIG. 8 shows the cylinders contained within a case 220.

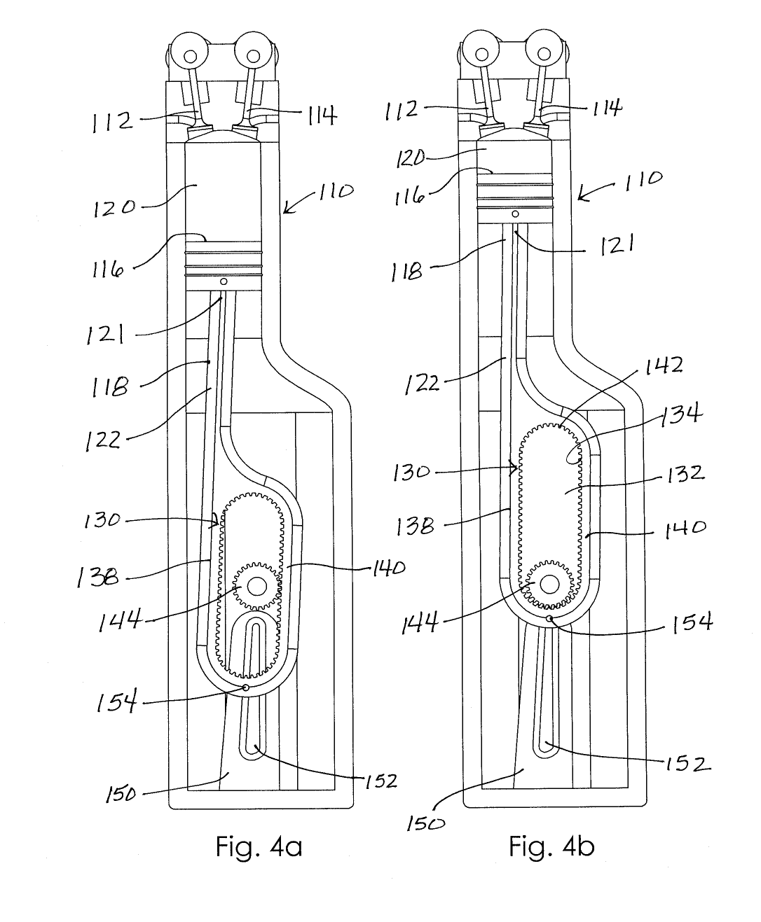

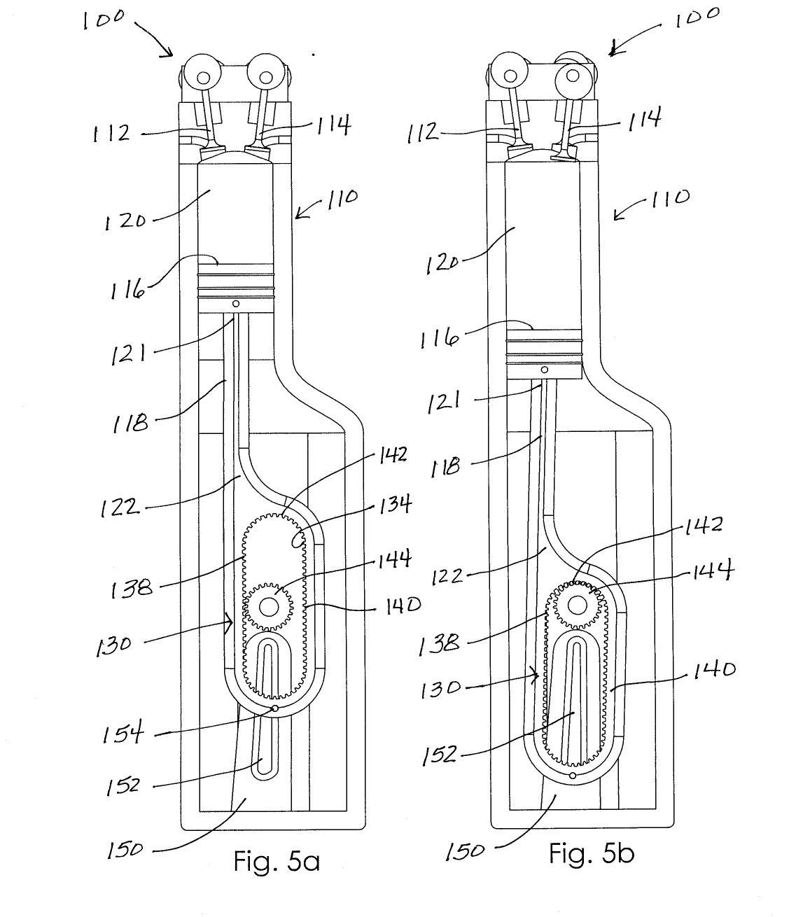

As shown particularly in FIGS. 4a, 4b, 5a, and 5b, the central gear 144 is continuously rotated by the moving rack gear 136 upon operation of the piston 116 and connecting rod 118. Note, however, that the central gear 144 does not change location as it rotates but, rather, the gear assembly 130 is moved vertically as the piston 116 and connecting rod 118 move vertically. In addition, the gear assembly 130 moves laterally as respective gear teeth 134 engage the central gear 144 as can be seen in FIGS. 4a, 4b, 5a, and 5b.

Operation of the enhanced combustion system 100 will now be explained with reference to the drawings. At FIG. 2a, the intake valve 112 is open such that air and fuel mixture may enter the air and fuel chamber 120. Entry of air and fuel pushes the piston 116 downwardly. Accordingly, the connecting rod 118 moves downwardly, causing the gear assembly 130 to rotate the central gear 144.

At FIG. 2b, operation of the central gear 144 with the second rack portion 140 of the rack gear 136 causes an upward movement of the connecting rod 118. Accordingly, the piston 116 compresses the air/fuel mixture in the fuel chamber 120 and creates high pressure. Both valves 112, 114 remain closed. When fully compressed, i.e. the piston 116 is at or near the top of the cylinder 100, a sparkplug (not shown) provides a spark so as to cause combustion of the compressed air/fuel mixture. As shown in FIG. 2c, the combustion causes a dramatic expansion of the volume of the air/fuel mixture and the piston 116 and connecting rod 118 are urged downwardly rapidly in the cylinder 100. Rapid downward movement of the connecting rod 118 causes rapid movement of the gear assembly 130 and corresponding rotation of the central gear 144. This rapid production of power is referred to as the “power stroke.” It can be seen that the power stroke is very efficient in the present invention in that the configuration of the gear assembly 130 and the rod 118 are in almost perfect vertical alignment and, thus, avoid the inefficient angle of a traditional crankshaft system.

In FIG. 2d, the power cylinder's internal piston 116 is pushed upward by the connecting rod 118 to exhaust a previous fuel combustion. The central gear 144 is engaged by the second rack portion 140 of the rack gear 136 and in almost perfect vertical alignment with the connecting rod 118.

Accordingly, the traditional combustion system for an internal combustion engine is improved dramatically through a connecting rod 118 that is pivotally attached to the piston 116 and that is maintained in almost perfect vertical alignment therewith through all stages of the power cycle. Use of an oval shaped gear assembly and rotatable central gear as a substitute to a traditional crankshaft provides an unexpected yet dramatic improvement to power generation in a combustion engine.

In another aspect of the invention, means are provided for customizing an engine to provide either more speed or more power. Specifically, it would be desirable to move the piston faster or slower than the crankshaft. The size of the stroke of the piston rod/chain can be adjusted to allow the piston to move faster or slower than the crankshaft. The benefit of moving the crankshaft slower than the piston is having an engine that applies more pressure to the crankshaft for the duration of the power stroke.

It is understood that while certain forms of this invention have been illustrated and described, it is not limited thereto except insofar as such limitations are included in the following claims and allowable functional equivalents thereof.

1. A combustion system for use with a vehicle having a transmission, comprising:
a power cylinder having a continuous side wall defining an interior area and having an upper end and an opposed lower end, said power cylinder having an intake valve and an exhaust valve situated at said upper end;
wherein said power cylinder defines an air/fuel chamber adjacent said upper end;
a piston situated in said interior area and movable between said upper end and said lower end;
a rod having a first end pivotally connected to a bottom of said piston and extending downwardly therefrom to a second end displaced from said first end;
a gear assembly coupled to the second end of said rod, said gear assembly being selectively movable in said interior area according to movement of said piston and said rod;
wherein said gear assembly includes:
a 360 degree rack gear member;
a central gear situated in said interior area of said power cylinder and in operative communication with said rack gear member, said central gear being configured to rotate when said gear assembly is moved upwardly or downwardly in said interior area;
a power shaft fixedly coupled to said central gear and configured to rotate when said central gear is rotated, said power shaft being operatively coupled to the transmission of the vehicle.

2. The combustion system as in claim 1, wherein said rack gear member includes:
a first rack portion having a plurality of teeth arranged in an upstanding configuration;
a second rack portion having a plurality of teeth arranged in an upstanding configuration, said second rack portion displaced from and facing said first rack portion;
a pair of end rack portions having a plurality of teeth connecting ends of said first rack portion to ends of said second rack portion, respectively.

3. The combustion system as in claim 2, wherein said pair of end rack portions are spur gears having a generally arched configuration.

4. The combustion system as in claim 2, wherein said gear assembly has a generally oval configuration and defines a central cutout, said plurality of teeth of said first rack portion, said second rack portion, and said pair of end rack portions are arranged along a peripheral surface defining said central cutout.

5. The combustion system as in claim 1, wherein said gear assembly has a generally oval configuration and defines a central cutout, said rack gear member being situated along a peripheral surface defining said central cutout.

6. The combustion system as in claim 1, wherein said central gear is rotatably coupled to said continuous wall of said power cylinder.

7. The combustion system as in claim 4, wherein said central gear is rotatably coupled to said continuous wall of said power cylinder and is at all times situated within said central cutout.

8. The combustion system as in claim 5, wherein said central gear is rotatably coupled to said continuous wall of said power cylinder and is at all times situated within said central cutout.

9. The combustion system as in claim 1, wherein said first end of said rod pivots relative to said piston as said central gear communicates with said first rack portion, said second rack portion, and said pair of end rack portions, respectively, such that said rod is configured at all times in generally vertical alignment with said rack gear member.

10. The combustion system as in claim 1, wherein said first end of said rod pivots relative to said piston as said central gear communicates with said rack gear member of said gear assembly such that said rod is situated at all times in generally vertical alignment with said rack gear member.

11. The combustion system as in claim 1, wherein said central gear defines a horizontal axis and said rod defines a vertical axis generally perpendicular to said horizontal axis.

12. The combustion system as in claim 1, wherein:
said gear assembly includes a flange extending away therefrom; and
said power cylinder includes a support member positioned in said interior area adjacent said lower end thereof that defines a vertically oriented slot configured to receive said flange, wherein to stabilize movement of said gear assembly.

13. A combustion system for use with a vehicle having a transmission, comprising:
a power cylinder defining an interior area and having an upper end and an opposed lower end, said power cylinder having an intake valve and an exhaust valve situated at said upper end;
wherein said power cylinder defines an air/fuel chamber adjacent said upper end;
a piston situated in said interior area and movable between said upper end and said lower end;
a rod having a first end pivotally connected to a bottom of said piston and extending downwardly therefrom to a second end displaced from said first end;
a gear assembly coupled to the second end of said rod, said gear assembly being selectively movable in said interior area according to movement of said piston and said rod;
wherein said gear assembly includes:
a 360 degree rack gear member;
a central gear situated in said interior area of said power cylinder and in operative communication with said rack gear member, said central gear being configured to rotate when said gear assembly is moved upwardly or downwardly in said interior area; and
wherein said central gear is operatively coupled to transmission of the vehicle.

14. The combustion system as in claim 13, comprising a power shaft fixedly coupled to said central gear and configured to rotate when said central gear is rotated, said power shaft being operatively coupled to the transmission of the vehicle.

15. The combustion system as in claim 13, wherein said rack gear member includes:
a first rack portion having a plurality of teeth arranged in an upstanding configuration;
a second rack portion having a plurality of teeth arranged in an upstanding configuration, said second rack portion displaced from and facing said first rack portion;
a pair of end rack portions having a plurality of teeth connecting ends of said first rack portion to ends of said second rack portion, respectively.

16. The combustion system as in claim 15, wherein said gear assembly has a generally oval configuration and defines a central cutout, said plurality of teeth of said first rack portion, said second rack portion, and said pair of end rack portions are arranged along a peripheral surface defining said cutout, respectively.

17. The combustion system as in claim 13, wherein said gear assembly has a generally oval configuration and defines a central cutout, said rack gear member being situated along a peripheral surface defining said central cutout.

18. The combustion system as in claim 13, wherein said central gear is rotatably coupled to a continuous wall of said power cylinder.

19. The combustion system as in claim 16, wherein said central gear is rotatably coupled to a continuous wall of said power cylinder and is at all times situated within said central cutout.

20. The combustion system as in claim 15, wherein said first end of said rod pivots relative to said piston as said central gear communicates with said first rack portion, said second rack portion, and said pair of end rack portions, respectively, such that said rod is configured at all times in generally vertical alignment with said rack gear member.

21. The combustion system as in claim 13, wherein said central gear defines a horizontal axis and said rod defines a vertical axis generally perpendicular to said horizontal axis.

22. The combustion system as in claim 13, wherein:
said gear assembly includes a flange extending away therefrom; and
said power cylinder includes a support member positioned in said interior area adjacent said lower end thereof that defines a vertically oriented slot configured to receive said flange, wherein to stabilize movement of said gear assembly.
